(19) United States
(12) Patent Application Publication
(10) Pub. No.: US 2012/0275643 A1
(43) Pub. Date: Nov. 1, 2012

(54) Purchasing Photographic Products from a Software Application on a Mobile Electronic Device Application

(75) Inventors: Timothy C. Beckford, Wesley Chapel, FL (US); Aaron M. Drenberg, Orlando, FL (US)

(73) Assignees: Aaron M. Drenberg, Orlando, FL (US); Timothy C. Beckford, Wesley Chapel, FL (US)

(21) Appl. No.: 13/351,458

(22) Filed: Jan. 17, 2012

Related U.S. Application Data
(60) Provisional application No. 61/433,689, filed on Jan. 18, 2011.

(51) Int. Cl. G06K 9/00

(52) U.S. Cl. 382/100

(57) ABSTRACT

The present invention relates generally to a method for purchasing photographic products. More particularly, the present invention allows a user of a software application on a mobile electronic device to purchase photographic products.

### FIELD OF THE INVENTION

The present invention relates generally to a method for purchasing photographic products. More particularly, the present invention allows a user of a software application on a mobile electronic device to purchase photographic products.

### BACKGROUND OF THE INVENTION

With the advance of technology, particularly of mobile phones and electronic devices, a user is able to browse through one's own photos or photos transferred from other users via email, infrared connection, retrieved from online archives and other transfer media. The capabilities for manipulating photographs and retrieving physical copies are limited on mobile phones and electronic devices. It is therefore an object of the present invention to introduce a method for allowing the user of a software application on a mobile electronic device to manage and purchase photographic products.

### BRIEF DESCRIPTION OF THE DRAWINGS

FIG. 1 is an image of the present invention, prompting for a user's billing and shipping information.

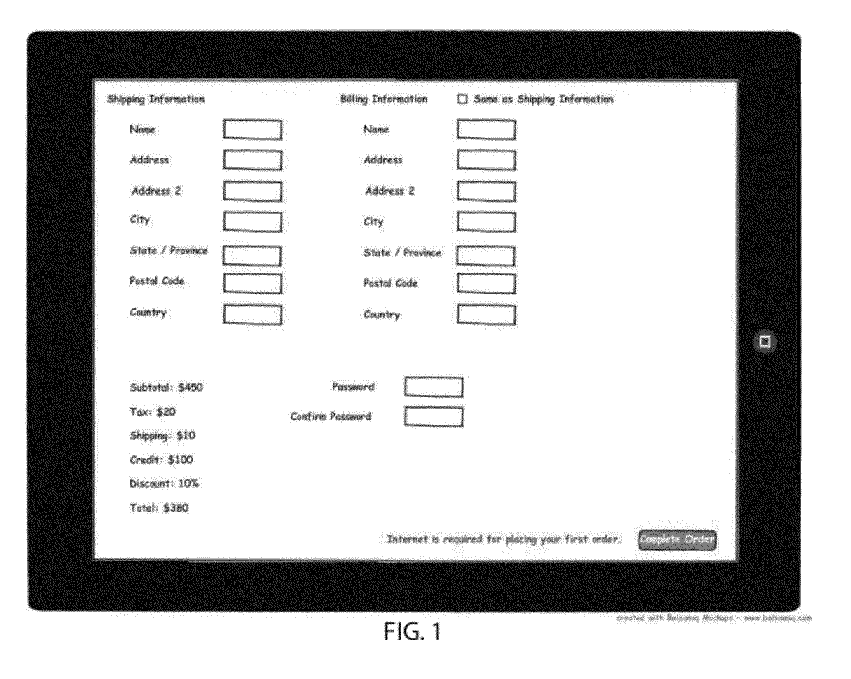

FIG. 2 is an image of connecting to a social network i.e. Facebook or Twitter, of the present invention.

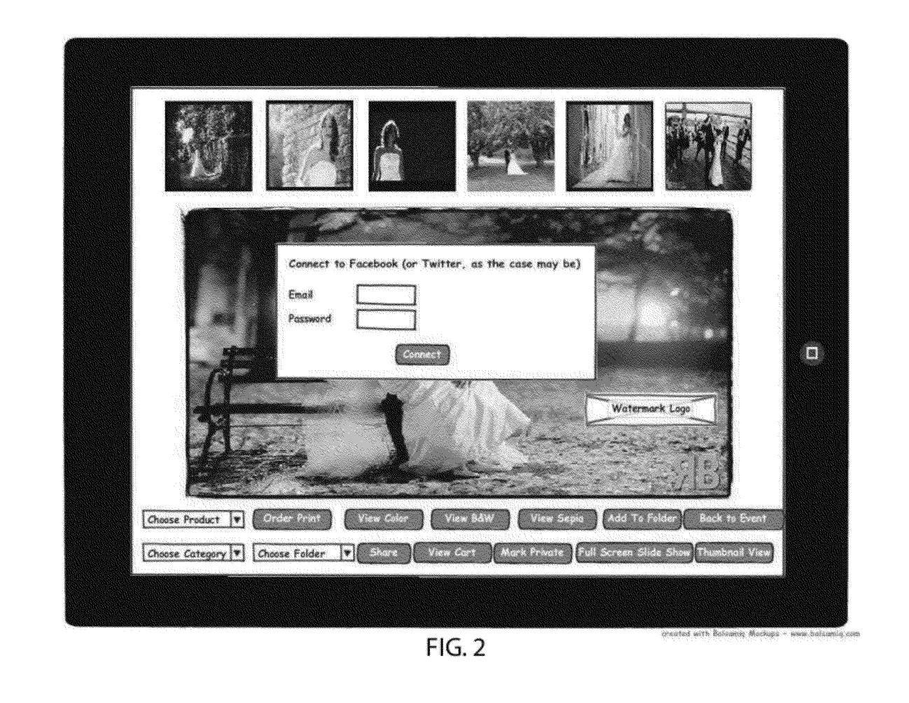

FIG. 3 is an image of the present invention, prompting for credit card information.

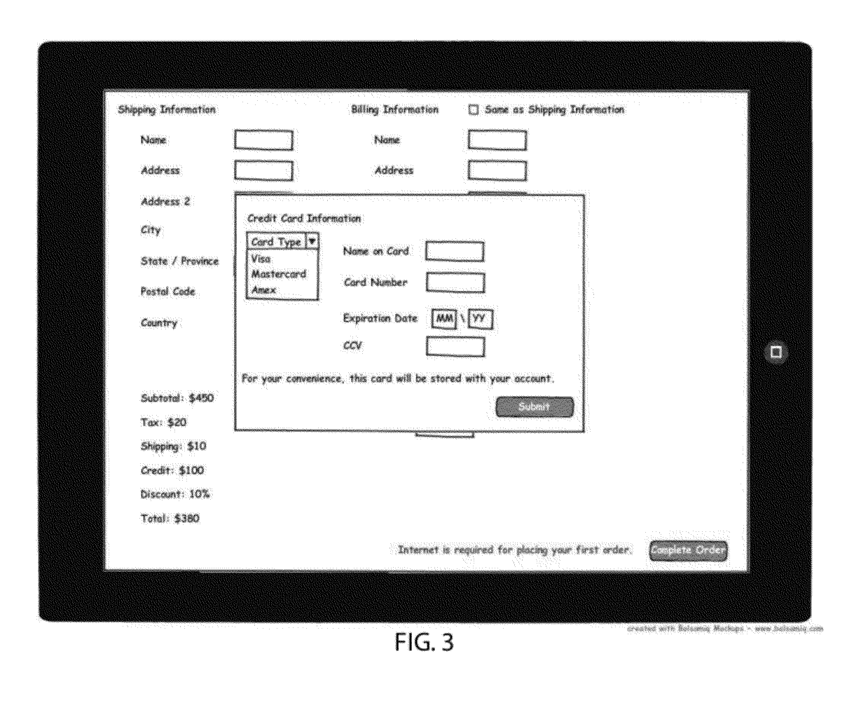

FIG. 4 is an image of the present invention, demonstrating a cropping capability.

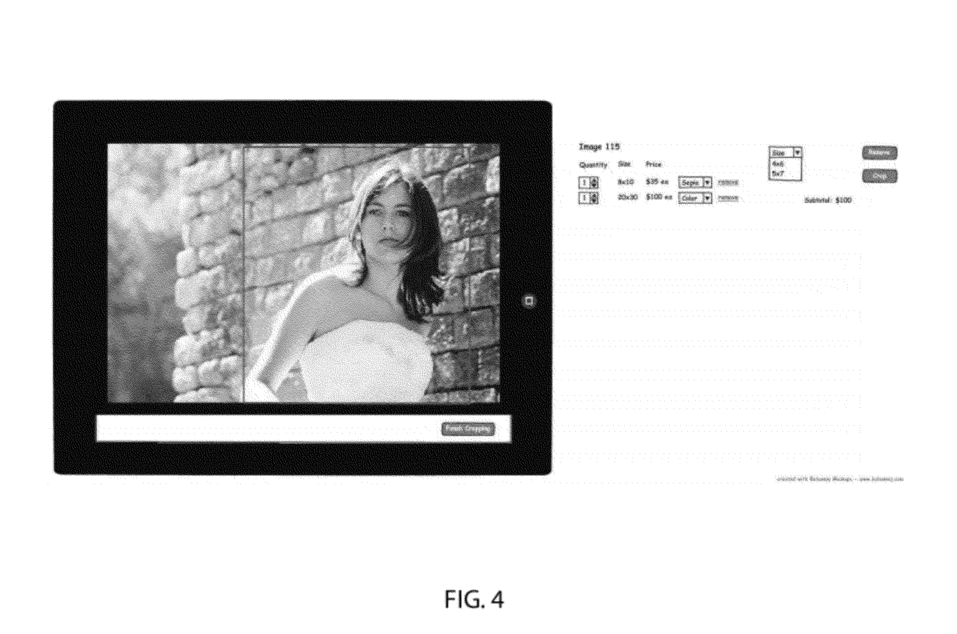

FIG. 5 is an image of a view cart of the present invention, allowing the user to view the purchasable photographs in the cart.

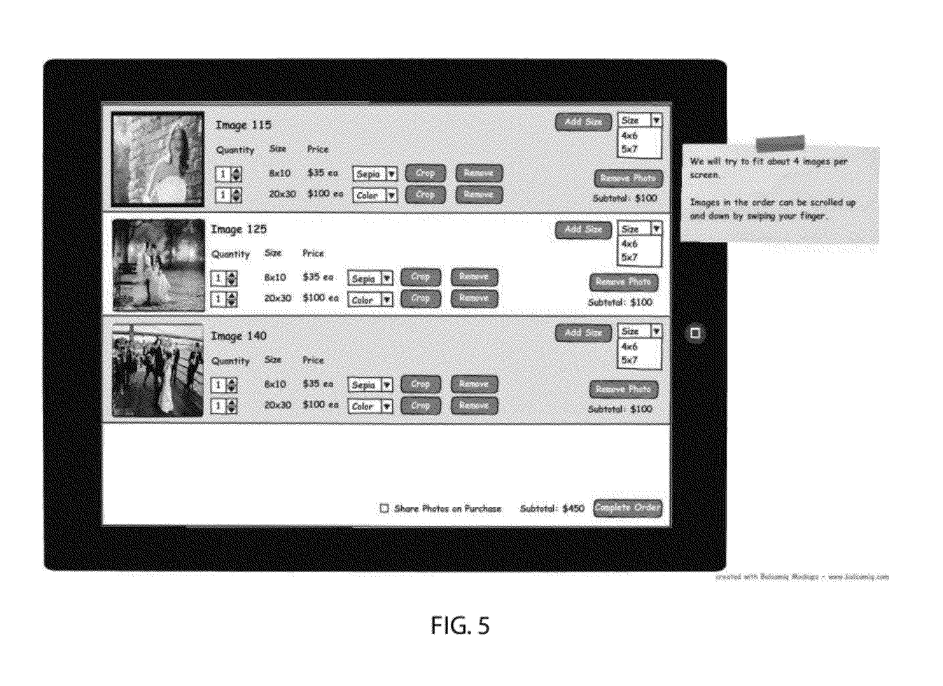

FIG. 6 is an image of a home screen of the present invention.

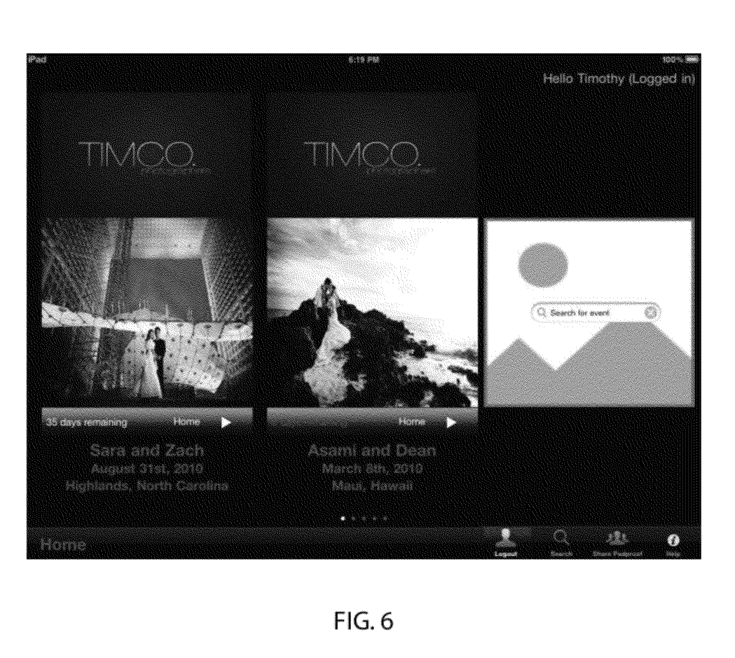

FIG. 7 is an image of a sample photograph in a slide show of the present invention.

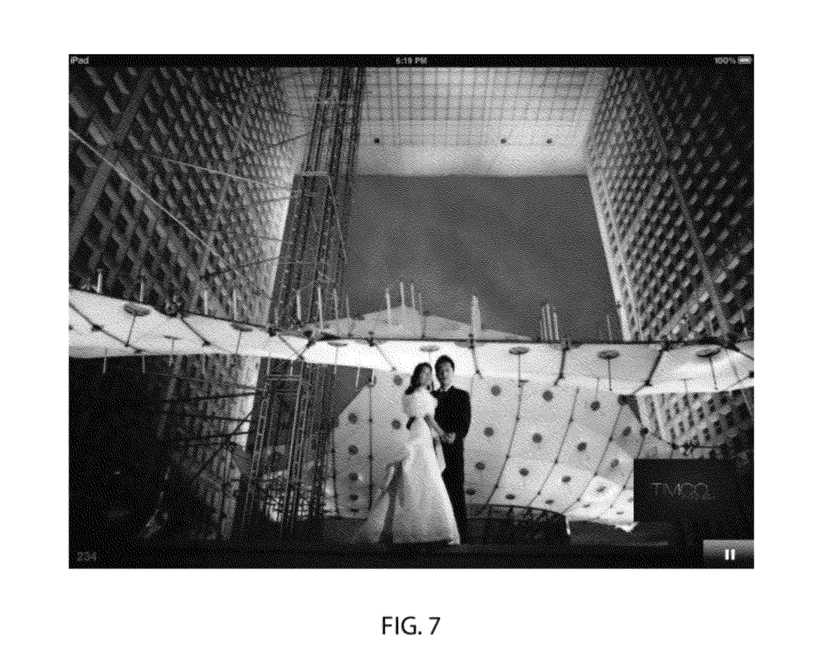

FIG. 8 is an image of the sample photograph in a slideshow, demonstrating thumbnails with image numbers and a Twitter/Facebook/E-mail sharing popup.

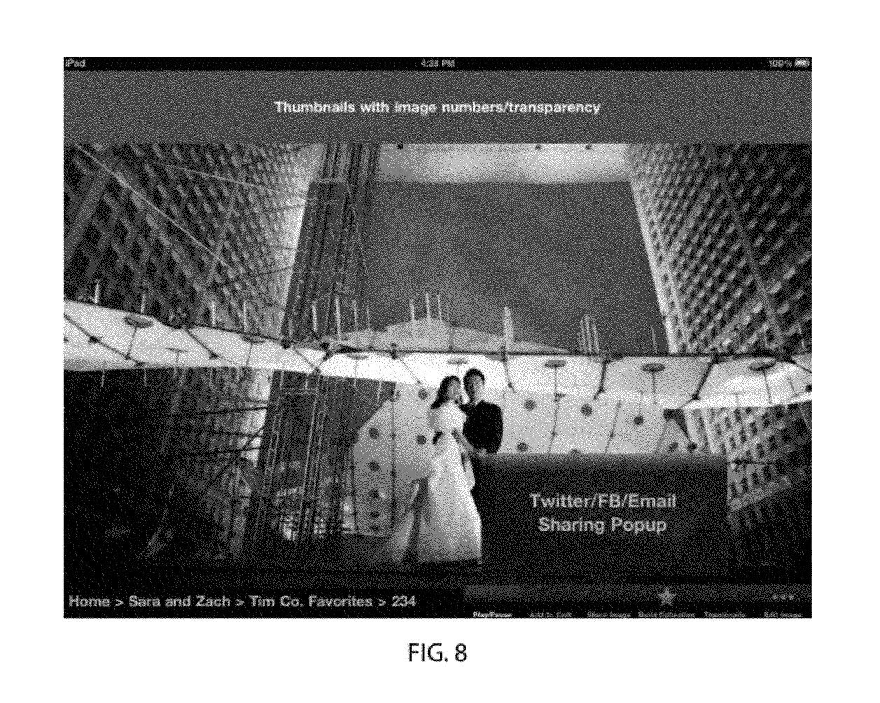

FIG. 9 is an image of adding images to the shopping cart of the present invention.

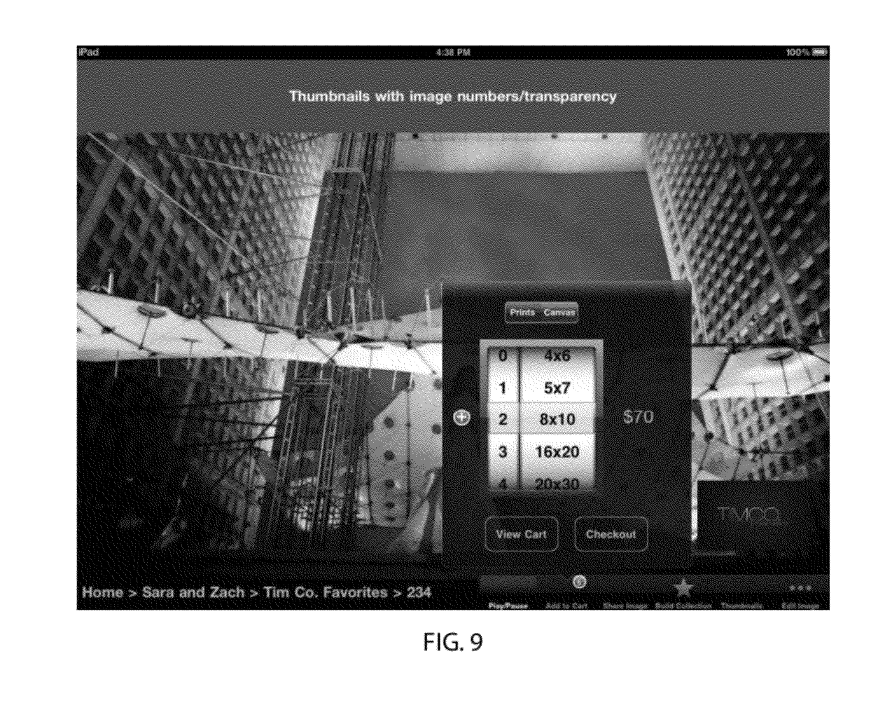

FIG. 10 is an image of the thumbnails view of the present invention with a Twitter/FB/Email sharing popup.

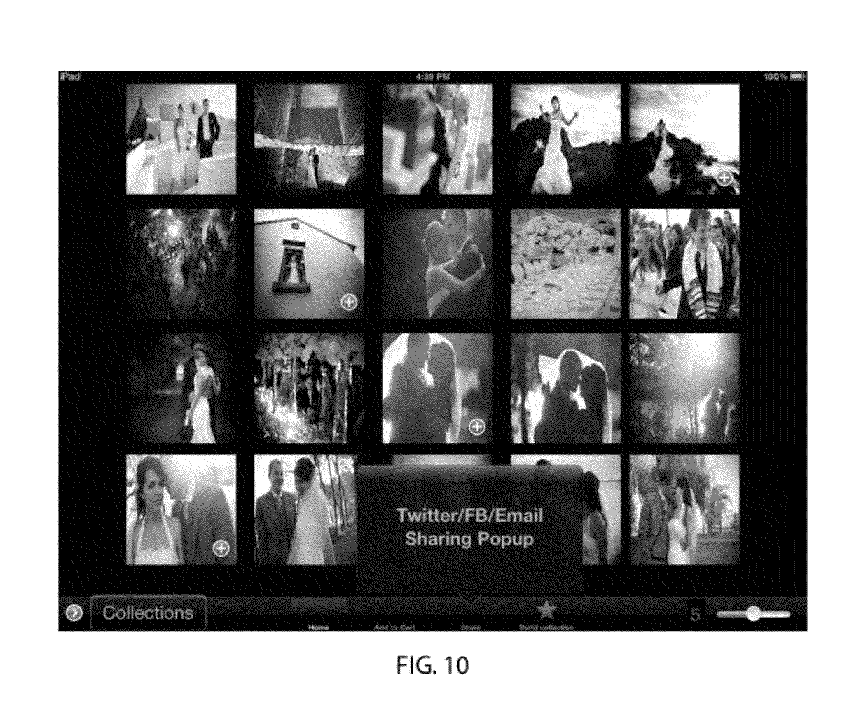

FIG. 11 is an image of a thumbnails view of the present invention showing only images from a user specified collection.

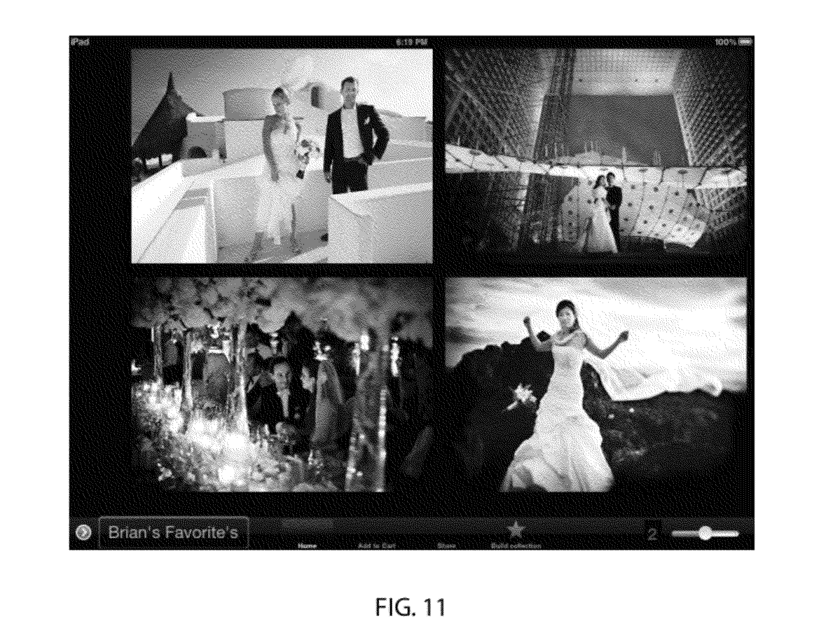

FIG. 12 is an image of the event home screen of the present invention.

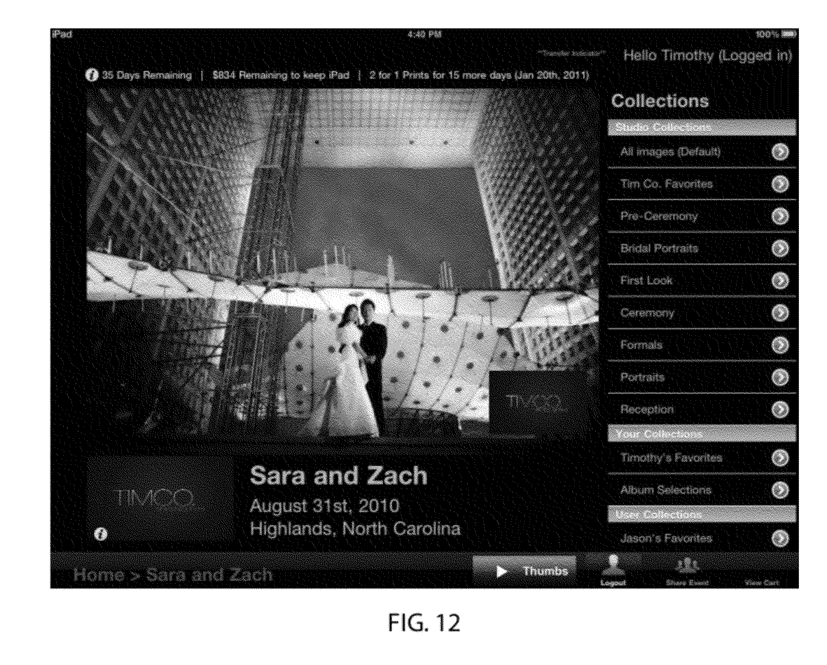

### DETAIL DESCRIPTIONS OF THE INVENTION

The present invention, herein referred to as PadProof, allows the user of a software application on a mobile electronic device to purchase photographic products. Photographic products can be defined as photographic prints, canvas prints, photo albums, and digital image file downloads. Software application on a mobile electronic device can be defined as any software process or program running on any electronic device that is considered to be a mobile device, such as the iPad, iPhone, Blackberry, both tablet computers and smart phones etc.

The invention works by allowing the user of the software application to view and manage photographic images on the mobile electronic device. The user can select specific photographic images to purchase. Once ordered and purchased, payment will be sent to a merchant account, and the photographic images will be shipped to the user.

The present invention comprises photographic images, a software application that has been written to function on a mobile electronic device, and a mobile electronic device.

Included here is a technical specification for the software, which is to be used with the mock-ups of user screens. The following is a list of the features, functions, and capabilities available for a user of the present invention.

View photographs as a slide show on a mobile electronic device.

The user can view photographs from any photographic collection as a slide show.

View photographs as thumbnails on a mobile electronic device.

The user can view photographs from any photographic collection as a collection of thumbnails.

Share photographs from a mobile electronic device via Facebook, Twitter, or email.

The user can choose any photograph, from any photograph collection, and share that photograph through email, Facebook, or Twitter. The photograph is watermarked when it is shared. The shared photograph may also include a link to a website.

Organize photographs on a mobile electronic device into pre-defined collections and/or custom user collections.

The user can choose any photograph from any photographic collection, and group that photograph into a collection that is pre-defined by the application or custom defined by the user.

Zoom into photographs on a mobile electronic device.

When viewing a photograph, the user can zoom in to enlarge the photograph.

View photographs in different tones, such as black and white or sepia, on a mobile electronic device.

When viewing a photograph, the user can choose to view the photograph in different tones, such as black-and-white or sepia.

Crop photographs on a mobile electronic device.

When adding a photograph to the shopping cart, the user can select an area of the image to be cropped. The crop ratio is based on the size of the print that is being ordered.

Download photographic collections onto a mobile electronic device.

The application can download collections of photographs into the device from an external source.

Synchronize photographic collections onto a mobile electronic device.

The application will detect when changes have been made, such as new photographs being added, to photographic collections and update the mobile electronic device to mirror changes made to the external source.

Synchronize Event data to a mobile device from an external source.

The application will detect when changes have been made to event data stored in an external source such as the name of the event, event availability, sequencing of event collections, event location etc. and mirror changes within the software application.

Limit access to a photographic collection based upon a time duration/expiration date.

The application will limit access to photographic collections to a specified duration synchronized from an external source. If the present time is outside this duration the photographic collection will not be accessible.

View a list of photographic collections on a mobile electronic device.

The user can view a list of each photographic collection that has been downloaded onto the device.

Add photographs to a shopping cart on a mobile electronic device.

The user can add photographs to a shopping cart on the device. The shopping cart is a holding area for photographs in review to be purchased.

Purchase photographs on a mobile electronic device.

The user can purchase photographic products generated from the selected photographs in their shopping cart from within the mobile application.

Authenticate a user account for Facebook and Twitter from a mobile electronic device.

The user can authenticate account access for Facebook and Twitter from within the mobile application.

Purchase photographs on a mobile electronic device that is not currently connected to the internet.

The user can purchase the photographs in their shopping cart from within the mobile application when no internet access is available. The orders are stored securely on the device until an internet connection becomes available. Then the orders are placed through the internet connection.

Search for photograph collection on a mobile device from an external database.

The user can search collections of photographs that are available for download onto the device. The information on the available collections of photographs is obtained from a source external of the application.

Control public/private viewing ability of a photograph on a mobile device based on user login.

The user can control whether a photograph can be viewed publicly by any other user, or whether the photograph can only be viewed privately by authorized users.

Display water marking of photographs on a mobile electronic device.

The application will display watermarks on each photograph in each photographic collection.

Log in user from the mobile device using credentials verified against a source external to the application.

The user can log into the application using credentials that are verified against a source external to the application.

1. Included here is a technical specification for the software, which is to be used with the mock-ups of user screens. The following is a list of the features, functions, and capabilities available for a user of the present invention.
View photographs as a slide show on a mobile electronic device.
The user can view photographs from any photographic collection as a slide show.
View photographs as thumbnails on a mobile electronic device.
The user can view photographs from any photographic collection as a collection of thumbnails.
Share photographs from a mobile electronic device via Facebook, Twitter, or email.
The user can choose any photograph, from any photograph collection, and share that photograph through email, Facebook, or Twitter. The photograph is 15 watermarked when it is shared. The shared photograph may also include a link to a website.
Organize photographs on a mobile electronic device into pre-defined collections and/or custom user collections.
The user can choose any photograph from any photographic collection, and group that photograph into a collection that is pre-defined by the application or custom defined by the user.
Zoom into photographs on a mobile electronic device.
When viewing a photograph, the user can zoom in to enlarge the photograph.
View photographs in different tones, such as black and white or sepia, on a mobile electronic device.
When viewing a photograph, the user can choose to view the photograph in different tones, such as black-and-white or sepia.
Crop photographs on a mobile electronic device.
When adding a photograph to the shopping cart, the user can select an area of the image to be cropped. The crop ratio is based on the size of the print that is being ordered.
Download photographic collections onto a mobile electronic device.
The application can download collections of photographs into the device from an external source.
Synchronize photographic collections onto a mobile electronic device.
The application will detect when changes have been made, such as new photographs being added, to photographic collections and update the mobile electronic device to mirror changes made to the external source.
Synchronize Event data to a mobile device from an external source.
The application will detect when changes have been made to event data stored in an external source such as the name of the event, event availability, sequencing of event collections, event location etc. and mirror changes within the software application.
Limit access to a photographic collection based upon a time duration/expiration date.
The application will limit access to photographic collections to a specified duration synchronized from an external source. If the present time is outside this duration the photographic collection will not be accessible.
View a list of photographic collections on a mobile electronic device.
The user can view a list of each photographic collection that has been downloaded onto the device.
Add photographs to a shopping cart on a mobile electronic device.
The user can add photographs to a shopping cart on the device. The shopping cart is a holding area for photographs in review to be purchased.
Purchase photographs on a mobile electronic device.
The user can purchase photographic products generated from the selected photographs in their shopping cart from within the mobile application.
Authenticate a user account for Facebook and Twitter from a mobile electronic device.
The user can authenticate account access for Facebook and Twitter from within the mobile application.
Purchase photographs on a mobile electronic device that is not currently connected to the internet.
The user can purchase the photographs in their shopping cart from within the mobile application when no internet access is available. The orders are stored securely on the device until an internet connection becomes available. Then the orders are placed through the internet connection.
Search for photograph collection on a mobile device from an external database.
The user can search collections of photographs that are available for download onto the device. The information on the available collections of photographs is obtained from a source external of the application.
Control public/private viewing ability of a photograph on a mobile device based on user login.
The user can control whether a photograph can be viewed publicly by any other user, or whether the photograph can only be viewed privately by authorized users.
Display water marking of photographs on a mobile electronic device.
The application will display watermarks on each photograph in each photographic collection.
Log in user from the mobile device using credentials verified against a source external to the application.
The user can log into the application using credentials that are verified against a source external to the application.
